(19) United States
(12) Patent Application Publication
(10) Pub. No.: US 2008/0059617 A1
(43) Pub. Date: Mar. 6, 2008

(54) SERVICE ENGINE FOR SHARING SERVICES, KNOWLEDGE AND EXPERTISE

(75) Inventor: David M. Abrams, Delmar, NY (US)

Correspondence Address: HESLIN ROTHENBERG FARLEY & MESITI PC, 5 COLUMBIA CIRCLE, ALBANY, NY, 12203, US

(73) Assignee: HELPGUEST TECHNOLOGIES, INC., Delmar, NY (US)

(21) Appl. No.: 11/467,998

(22) Filed: Aug. 29, 2006

(51) Int. Cl. G06F 15/173

(52) U.S. Cl. 709/223

(57) ABSTRACT

End user clients and experts are provided with a method for connecting with one another in a secure and anonymous fashion. Previously supplied protocols permit users of the method to define criteria for allowing a connection based both upon supplied key words and also upon specified preferred or required communication modalities. The protocols interact with a dispatch servicer running on a first server but the parties connect through address and port information defined on a second server operating as a tunneling server providing secure connections for video, text based chat, VoIP, remote access or other transfers of information.

### TECHNICAL FIELD

The present invention is generally directed to systems and methods for providing and exchanging services, knowledge and/or expertise over a computer network. More particularly, the present invention employs a services engine which enables two or more computers to communicate across a network by using a third party to negotiate content, distribution channels, and access security.

### BACKGROUND OF THE INVENTION

The present system was designed to solve the problem of enabling a secure connection between two computers in which at least one of the computer operators is technically incapable of ensuring the level of security desired. The present invention was developed as a result of problems that occur in the use of a widely available open source software package called secure shell (SSH). When used to build “network tunnels” (see below for definition), there is a known threat called the “man in the middle attack.” A network tunnel is a connection, across a network, having certain characteristics. The tunnel provides the ability for two computer systems on disparate networks to exchange data as if they reside within the same network and to act as if they have a direct connection to one another. Network tunnels are used to send data over a network using a protocol for which the data was not designed and for which it would not pass through without a “tunnel.” In cryptography, a man in the middle (MITM) attack occurs when an attacker is able to read, insert and modify at will, messages between two parties without either party knowing that the link between them has been compromised.

The present invention relies instead on a trusted “man in the middle” to negotiate content, distribution channels and security. It is also noted that there is a known mechanism for connecting disparate systems that is known as a peer-to-peer (P2P) network connection. The advantage of the present invention over P2P networks is twofold. First, the services engine herein allows anonymity between the parties to be preserved, whereas a P2P network requires each system location (network id/port) to be known to all other systems, including third party systems for routing purposes. Second, the present invention allows “intelligence” to be placed with the middleman so that communication is managed in ways not available in a P2P network.

### SUMMARY OF THE INVENTION

The shortcomings of the prior art are overcome and additional advantages are provided in a method for establishing communications in a network. The method includes the step of identifying at least one party to a service engine, via a predefined protocol. A determination is then made as to whether or not conditions are satisfactory for communications, as defined by the protocol. Upon a successful determination, information is exchanged in a manner in which the parties involved are anonymous to one another but which are known to the service engine.

In another aspect of the present invention there is provided a system for establishing communication between parties. The system comprises a first processing unit running a web server and being capable of identifying at least two parties via a predefined protocol. The system also includes a dispatch service program running on the first processing unit for determining whether conditions, as defined by the protocol, are satisfactory for communications between at least two of the parties. Importantly, for most but not all usages, there is also provided a secure tunneling server which includes a second processing unit and an available network location, as determined by the dispatch service program, through which the communications pass. In this manner the parties are anonymous to one another but are known only to the dispatch service program.

The present invention provides a method in which parties that are not known to one another are identified through the use of a first server and later connected in a secure way through a second server characterized as being a “tunneling server” as that term is defined herein. A “tunneling server” is a server en which is capable of providing one or more network tunnels. In a tunneling server there is a state in which the service engine has no active tunnels. For example, when the server is initially turned on and before any clients are connected, such a state is the norm. In the present invention, in order to pass data via the service engine, a “tunnel” (as that term is intended herein) is provided in server 70. Tunnels are created on demand. Tunnel pairs/tuples are joined on demand. The tunneling server is capable of providing a plurality of such network tunnels which connect: (1) single clients to a single provider (one-to-one); (2) a plurality of clients to a single provider (one-to-many); (3) a plurality of providers to a single client (many-to-one); or (4) even multiple clients to multiple provider (many-to-many). Item No. 1 is typified by the services provided by a hired consultant. Item No. 2 is typified by the services provided by a professor to a class of students. Item No. 3 is typified by the services provided by a team of doctors to a single patient. Item No. 4 is typified by the services provided in a conference setting with a panel of experts.

Additional features and advantages are realized through the methods of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects advantages thereof, may best be understood by reference to the following description taken in connection with the accompanying drawings in which:

FIG. 1 provides an overall view of the structures and operations of the present invention and more particularly illustrates end-users establishing a connection to dispatch servicer via a web server;

FIG. 2 is a block diagram illustrating models of the system and, in particular, how the present invention differs from P2P systems;

FIG. 3 is a flow diagram, as shown from an end user's point of view, demonstrating the invention as it is intended to be used for connecting end-users and experts in a services marketplace; and

FIG. 4 is a flow diagram, as shown from an expert user's point of view, illustrating the invention as it is intended to be used for connecting end-users and experts in a services marketplace.

### DETAILED DESCRIPTION

The diagrams presented have been collected from various existing documents of the inventor and HelpGuest Technologies, Inc. As a result, the terms client and end-user are both used to indicate the same component in differing diagrams. The terms provider and expert are also interchangeable in the various diagrams. Also, as used herein, the term “services engine” is not meant to imply that any specific data processing system or programs are required. The “services engine” referred to herein is any data processing system that provides the services for users as described. “Services,” in the context of a “service engine,” refer to either (a) the experiential knowledge passed from one person (end-user) to another that involves the use of computer resources to share that knowledge or toward which that knowledge is directed (for example, as in a computer help desk type of service) or (b) computer applications that provide computing functionality with or without human intervention. A service engine is a means to aggregate and distribute the aforementioned services on a computing network. Unlike a search engine, which aggregates and distributes static data, a service engine is intended to provide dynamic acquisition of knowledge, data, and/or resources.

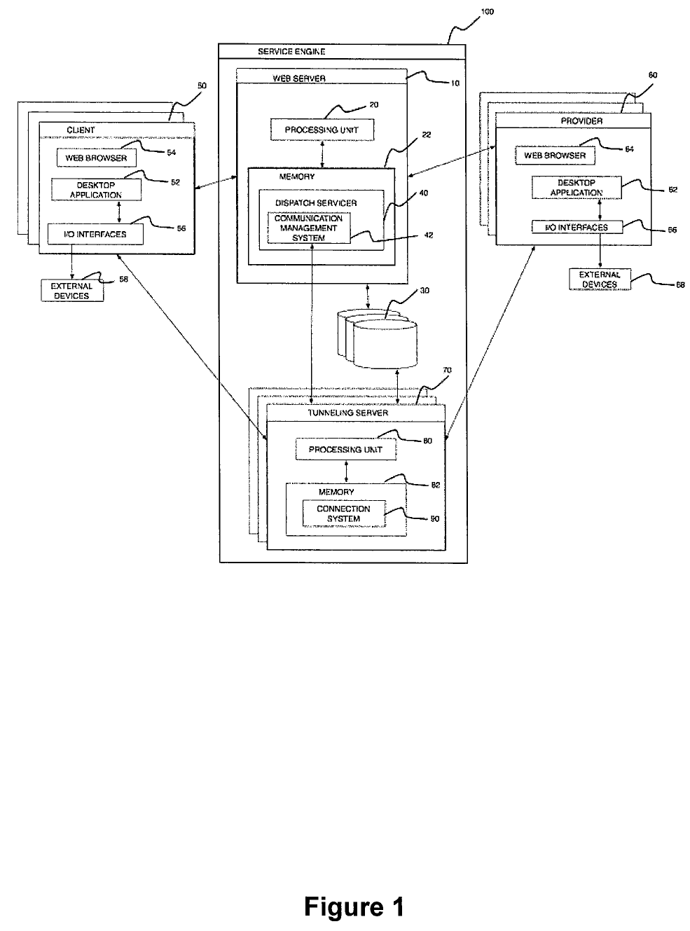

FIG. 1 illustrates a situation in which service provider 60 and service client 50 are communicating in real-time. The resources used in the communication typically include such things as keyboard input, mouse movement, voice transmission and/or hard drive and system processor access/sharing. Types of applications that enable this real-time communication include remote access, Voice Over Internet Protocol (VoIP) or other real time services such as live video, or other applications such as those which are capable of either establishing or carrying out communication functions. In general, the parties are able to indicate a desired or required communication modality or modalities.

In FIG. 1, each end-user (50 or 60) establishes a connection to dispatch servicer 40 via web server 10 in service engine 100. A typical client 50 includes web browser 54 for communicating with web server 10 in service engine 100. Client 50 also typically includes desktop application 52 which is coupled to the usual I/O interfaces 56 such as those that are found on personal computers which naturally include external devices 58. Having described a typical client end-user, it is noted that a typical provider end-user 60 also includes corresponding components: web browser 64, desktop application 62, I/O interfaces 66 and external devices 68. While FIG. 1 illustrates the typical configuration found at an end-user's location, it is noted that end-users 50 and 60, be they client or provider, may comprise a wide range of equipment and configurations. The only requirement is that each end-user have some means to send information via a data processing network.

Web server 10 includes processing unit 20 coupled to memory 22 which includes dispatch servicer 40 which in turn includes communication management system 42 which performs communication with tunneling server 70. Dispatch servicer 40 does not have to be present on a web server in all implementations of the present invention. Dispatch servicer 40 chooses and delegates a location for the two end-users, 50 and 60, to meet on tunneling server 70 which includes processing unit 80 with memory 82. Connection system 90 on tunneling server 70 is to be particularly distinguished from communication management system 42 on web server 10 since they do not need to be present on the same physical system. Moreover, the present invention contemplates the situation in which there are multiple tunneling servers 70 in any given implementation so as to provide scalability. The location on server 70, in this case, is secure due to the use of SSH; however, in general, any component that provides the same network tunneling functionality of SSH may also be used.

It should be noted that for all uses of the system under discussion the requirement for SSH security is not essential. However, for many of the applications that are enabled by the present invention, security is an important feature but it is not an absolute requirement for all intended uses. By not giving details of their locations, the client 50 and provider 60 (both being end-users in their own defined fashions) retain anonymity but still acquire the flexibility to connect with many others (providers or clients) who otherwise wouldn't know how to find them. SSH provides two functions in the present invention. First, it enables a means to establish network tunnels and second it uses cryptography for security. Network tunnels built via SSH are necessarily secured by cryptographic means. However, it is noted that in certain desired instances, network tunnels are built to join systems independent of security measures and without cryptography.

As used herein, the terms “client” and “provider” are not only different from one another but they are also used to distinguish each of them from the “third party” role that an operator of the present invention provides. Such an operator is typically the supplier or maintainer of service engine 100. However, the roles of the two end-users (client or provider), as an actual client or host in computing terms, are essentially indistinguishable relative to service engine 100. In normal operation, service engine 100 “perceives” them both as clients of itself. The invention under discussion is simply a means for communication between client 50 and provider 60 and their respective applications, 52 and 62. While typical applications (52 and 62) are those which run on personal computers and/or terminals, the description of these applications as being desktop applications is only intended to refer to their usual use; however, clients 50 and providers 60 may communicate via any convenient mechanism. At present, that mechanism is most likely to be based on personal computers and the Internet. Service engine 100 is a combination of dispatch server 40, nonvolatile storage 30 and one or more tunneling servers 70.

Tunneling server 70 includes processing unit 80 having memory 82. Memory 82 includes connection system 90. Connection system 90 enables real-time connections via the TCP/IP protocol; however, the present invention works with any convenient protocol such as UDP/IP.

Client 50 and provider 60 employ applications that utilize protocols provided by service engine 100 for communication with dispatch servicer 40 which includes communication management system 42. The function of communication management system 42 is to maintain a record of active and inactive clients to service engine 100 and to refer unique client/provider pairings and groupings to tunneling server 70. These protocols are flexible enough to add new types of real-time services as they become available. Clients 50 and 60 communicate between themselves after being introduced and connected via service engine 100. Preferably included in the service engine protocols are messages to access web server 10 and its component, dispatch servicer 40, as well as a protocol to access tunneling server 70 and specifically connection system 90.

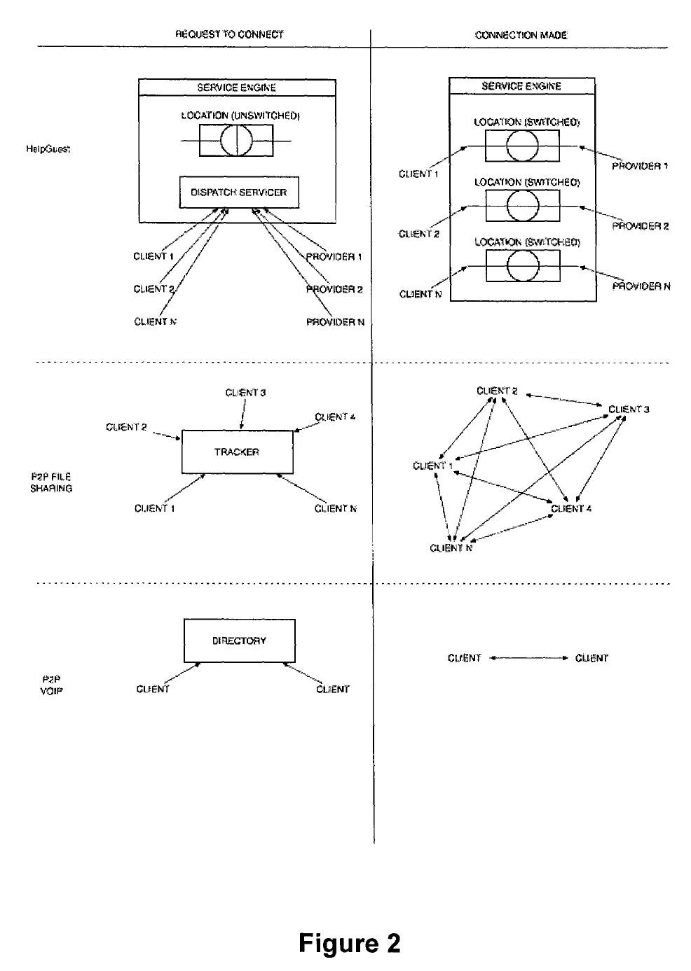

In the first row of the chart shown in FIG. 2, there is shown a simplified model of the system and, in particular, FIG. 2 illustrates how the present invention (identified as “HelpGuest” in the drawing) differs from P2P systems. The first row of the chart shown in FIG. 2 illustrates the operation of the present invention from the point of view of the requester making a “request to connect” (shown diagrammatically on the left) and from the point of view of the system in terms of the “connection being made” (shown diagrammatically on the right). The main difference is that existing P2P systems enable direct client-to-client communication across a Wide Area Network (WAN) or a Local Area Network LAN, whereas service engine 100 identifies a very specific location in the WAN/LAN where the client and provider connect. Note that there are variations to the connection patterns with the service engine (not shown in FIG. 2) in which multiple clients connect to a single provider. Note too that the model provided in the present invention is different than that provided by Voice Over Internet Protocols (VoIP; third row of the chart) in which connections are made via publicly available directories. It is noted, however, that this does not imply that VoIP connections cannot be established during the practice of the present invention. However, the present invention does provide the end-users with the opportunity to use VoIP in a fashion which assures a desired level of anonymity.

FIG. 2 also illustrates other aspects of the communications structures of the present invention. Clients 50 and providers 60 communicate with dispatch servicer 40 in accordance with protocols and exchanges described elsewhere herein. Dispatch servicer 40 matches clients and providers and provides for each connection that is to be established, a network connection on tunneling server 70. Each client and each provider is offered at least one address and port designation on tunneling server 70. This address and port information is used by the client and by the provider to enable a network tunnel with the tunneling server for each address/port designation provided. When appropriate matches are made, a tunneling structure is created by connection system 90 which joins each of the matching client and provider tunnels into single units based on information provided to dispatch servicer 40. The tunneling structure thereby allows the clients of the service engine to maintain a network connection via at least one network tunnel. In this way, the parties are unaware of each other's locations but both are able to communicate through the secure tunnel provided. In preferred embodiments of the present invention, security is provided through the use of SSH. Subsequent to the creation of this structure, a signal is provided to all of the relevant parties that communication can now begin. Bear in mind that connections may be provided between one or more clients and one or more providers, depending on the intended usage of the underlying services engine.

In the present invention, there is no requirement for a client 50 or provider 60 of service engine 100 to also be the ‘client’ in the tunneling relationship. In an alternate embodiment, it is possible for client 50 or provider 60 to be the “server” when building a tunnel or when enabling a Virtual Private Network (VPN) relationship. This still provides anonymity between two clients (or, more generally, end-users) of the service but not anonymity from the service.

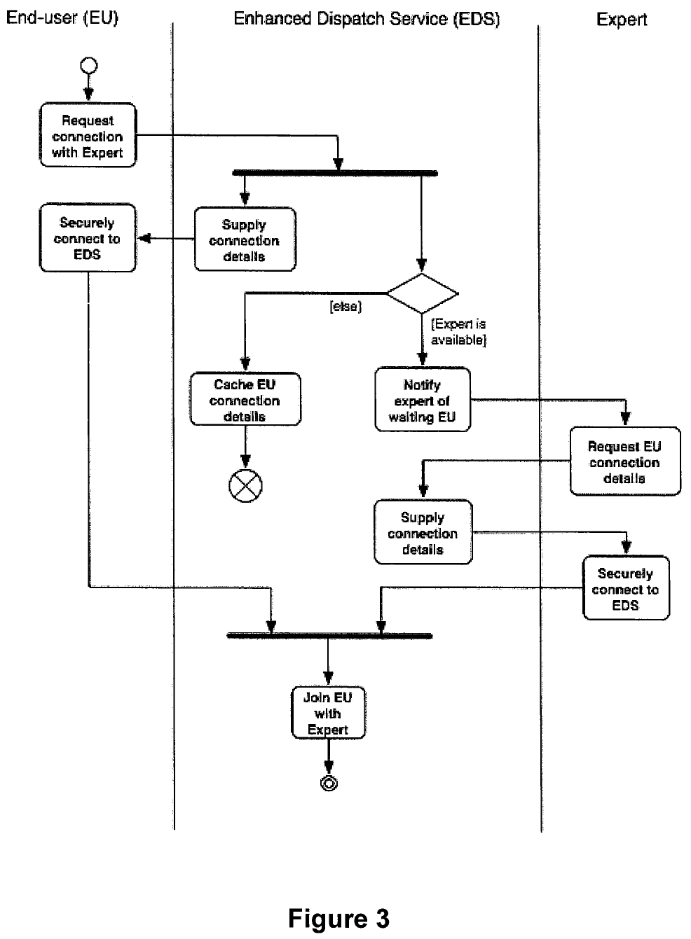

FIG. 3 is a flow diagram illustrating the invention as it is typically used to connect an end-user client to an expert. FIG. 3 illustrates the situation in which the communication is initiated by a client. At this point, the end-user already knows the specific subscribing provider with whom the end-user wishes to connect. By pre-selecting the Expert, end-user client application 50 is able to provide explicit details requesting to communicate with a specific instance of Expert application 60. It is noted that FIG. 3 does not indicate that part of the process in which the Expert is selected (for example, by keyword matching). Preliminarily, it should be understood that there are, in general, two phases of operation employed in the use of the present invention. In a first phase, an end user contacts the principle provider of services, typically the “owner” of servers 100 and 70. Once an account or subscription basis is established, an end user operates on his or her own, whether as client 50 or as subscribing provider 60 who responds to clients. Likewise, on the subscribing provider's side, contact is made with the principle provider of services (that is, the provider of the services enabled by the present invention). The subscribing provider, or Expert herein, supplies keywords to be matched by clients. A fee may be charged to the Expert for each keyword. A sliding scale of fees based on relevance or importance may be imposed on the Expert.

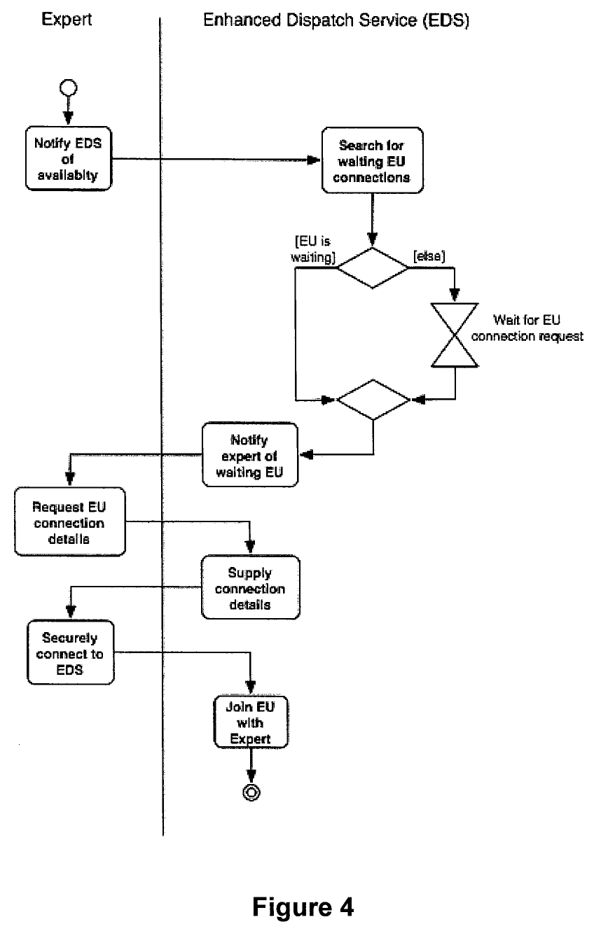

After a client has established themselves as a bona fide subscriber to the service, when such a client requests a connection with an Expert, application program 52 contacts dispatch servicer 40 in web server 10. Dispatch servicer 40 provides connection details to application code 52 and it awaits notification of the availability of a matching Expert. Dispatch servicer 40 contacts the requested Expert (or Experts) and awaits a response. In the meantime, details as to the connection details for the end-user client 50 are cached for future reference. Application software 62 running on the Expert's local system responds to the matched inquiry and requests connection details. Dispatch servicer 40 responds to the Expert's desktop application program 62 with these details. The desktop application then securely connects to dispatch servicer 40 which “opens the tunnel gate” so as to enable the parties to communicate. FIGS. 3 and 4 illustrate the invention in use with a predetermined end-user and expert pair. These diagrams indicate the least common denominator for a connection between parties on a service engine. The present invention preferably uses natural language keyword matching to narrow the universe of potential Experts from which the end-user chooses. This selection on the part of the end-user creates the aforementioned predetermined pair. Other connection algorithms will also rely on a predetermined pair algorithm to operate with the present invention. In another matching scheme, an end-user submits a problem for bidding to a system that would broadcasts a message to all qualified Experts asking them to submit a request for proposal (RFP). After the end-user selects which expert to use based on the RFP's, they are connected via a predetermined pair algorithm such as the one described above.

FIG. 4 is a flow diagram illustrating the invention as it is typically used to connect an end-user expert to a client. FIG. 4 illustrates the point in time at which communication is initiated by an expert to notify dispatch servicer 40 of the expert's availability. In response dispatch servicer 40 searches for any pending connection requests from client end-users. If there are none waiting, dispatch servicer 40 is placed in a wait state. If there is a pending connection request from a client, dispatch servicer 40 notifies application software 62 that an end user connection request is pending. Application software 62 then requests connection information from dispatch servicer 40, which supplies this information to application software 62. A connection is then made linking client and expert through a network tunnel provided in tunneling server 70. From this perspective, the process flow in FIGS. 3 and 4 ends up at the same point.

The above described system and method are also employable in a more general framework. In particular, some of the specific ways of using the system and methods are now described. For example, the present invention provides the infrastructure for improved “help desk” or “call center” operations. It enables clients who are in need of expert services to contact experts who are also subscribers to the service offered by the present invention. In the context of situations involving end-users seeking technical expertise help with their computer hardware and software problems, the present invention also enables a distant expert to view the computer screen of a client, and vice versa.

The present invention also provides a model for the exchange of information, services and data in which the operator of the invention is able to provide an assurance of the quality of the experts that are subscribers. Experts and clients are each enabled to subscribe to this service and each is charged a fee for doing so. Additionally, on the expert side, they also have the opportunity to pay a fee related to a verification of their expertise. This could be characterized, in one sense, as a reference check fee.

The present invention may also be employed in the context of gaming. In this case, both end-users are better characterized as being clients, although the use of the invention to acquire expert advice in gaming is also an equally viable use.

Because of the lack of limitations associated with applications 52 and 62, the present invention is also employable in the context of “see and hear” presentations such as those most closely associated with distance learning. In this context, the most likely scenario is that there are a plurality of clients and a single provider. However, in general, any number of clients and providers may be involved.

In an even broader context, the present invention provides a system and method which is intended to foster the growth of communities of users and experts grouped by subject area as need be. These areas include such diverse subjects as medical communities, engineering communities, educational communities, and even such communities as gardening, home repair and cooking. In fact, any area of human knowledge in which there is a collected body of knowledge is appropriate for inclusion as a defined community. However, more than just providing a portal into a relatively static library of knowledge, the present invention provides a mechanism for the live exchange of expert information that only exists in the heads of the provider subscribers.

Furthermore, it is noted that the present invention is not constrained to the use of any particular mechanism for either providing or enhancing security. The present invention is capable of working with any mechanism which is intended to provide security in the sense of providing anonymity of network location to the end-users. There are currently and typically three principal mechanisms for providing such security: encryption, digital signature, and authentication. Any other mechanism that is currently available or which is developed in the future including such methods as quantum encryption and transmission are also employable as that part of the present invention that assists in providing security and anonymity. In different security protocols, various ones of these methods are combinable with each other and with other mechanisms like message integrity to provide these desired functions. The primary feature of these methods and systems is the provision of anonymity and security.

Attention is now focused upon the usage model of the present invention, that is, a description of the ways in which it is used. Typically, client-user 50 contacts a provider of the services described herein, such as HelpGuest Technologies, Inc. Such a client is then provided with an application program 52 having defined therein protocols for establishing communications. These protocols include system specific parameters and also client specific parameters. Application program 52 is preferably provided via a network download, but may be provided by any convenient mechanism including shipment of media or the in-place construction of an executable application (for example, by the local compilation, assembly, interpreting or scripting of desired software components on the system from which it is to be run). Client 50 may or may not be charged a fee for application program 52. Fees may also be assessed as a function of future use. However, at this stage of the process client 50 is preferably provided with an agreement setting forth the terms and conditions of the service provided by the “owner” of service engine 100 and secure server 70.

One must be careful to avoid confusing references to the provider of the service herein (typically the “owner” of service engine 100 and tunneling server 70) with the provider of services that are requested by a client, the so-called subscribing provider. Where confusion is likely the terms “service provider” and “subscribing provider” are used; alternatively, reference numerals 50 and 60 also serve this purpose. Furthermore, in the context of the present invention both client 50 and subscribing provider 60 are clients of the service provider. Likewise, it is to be noted that client 50 and subscribing provider 60 are not precluded from establishing what is more aptly described as a client-to-client relationship. A provider-to-provider relationship is also possible.

Likewise, subscribing provider 60 contacts a provider of the service facilitated by the present invention. In the same manner as client subscriber 50, subscribing provider 60 is provided with application 62, preferably by download over the network. Application program 62 contains protocols that are subscription-provider-specific. In particular, subscribing provider 60 typically indicates the application specific services they are capable of. For example, these services include any of the following components; a remote access server, a remote access client, a chat server, a chat client, a VoIP client, a VoIP server, etc. These components are indicated by desktop applications 52 and 62. It is important to note that the expertise or experiential knowledge offered by a subscribing provider is not communicated to the services engine. In the present model, these details are outside the scope of the services engine. Keywords are a high level mechanism to match clients to subscribing providers. The present implementations of client 50 and subscribing provider 60 are distributed with the communications capabilities of remote access, chat, and VoIP. These may be client or server implementations of those communications services depending on the services engine client requests. It is noted that one of the bases available for a fee structure in the present invention is the establishment of a schedule of fees tied to the number of keywords provided to subscribing providers, with the further possibility of placing keywords in separate tiers with respect to cost. Such fees may be collected over any convenient period of time, say monthly. This is also characterizable as keyword subscription plan.

The process of the present invention provides each client application with the protocol details that it needs to connect with the subscribing provider through the present implementation of the services engine. In a typical scenario, an end-user enters a textual problem description into the principal provider's web site. The principal provider's web site in turn returns a list of subscribing providers whose keywords match the words in the problem description. The end-user then chooses one of those subscribing providers and requests to have a session with that subscribing provider, referred to herein as an “Expert,” as they claim to have the knowledge and the skills to solve end-users problems. The session between an end-user and an Expert is realized when the end-user runs application 52, as provided by the principal provider. Application 52 communicates the details necessary to connect with the selected subscribing provider 60. The subscribing provider communicates to service engine 100 that it will join in a tunneled network connection or connections to the end-user. Both client 50 and provider 60 request to join with one another for a successful connection to be made between the two. The keyword matches provide a primary basis under which client 50 and provider 60 may choose to establish a tunnel connection in a secure server. However, there also exists the generally desirable possibility of employing secondary criteria under which end-users choose which providers with whom to work. Such criteria include considerations of credential ratings, reviews by other system users, trust level and the like. The present invention also provides an opportunity for including a mechanism by which feedback evaluations of provider services is providable to the principal provider. Desktop applications 50 and 60 are preferably structured to maintain at least one channel of communication, separate from the tunnels that connect end-users 50 and 60 to each other, with the service engine during a session. This communication between the desktop application and service engine allows for observation of certain “pragmatic” variables. These variables include: session duration between two parties, feedback from one party about another, feedback about the operator of the service engine, the sustained presence or absence of each party (for example, if one party disconnects, the other party should be informed), and tunneling connection details should new tunnels need to be built or old ones removed.

Once it is determined by dispatch servicer 40 that a match is appropriate, the network tunnels unique to client 50 and subscribing provider 60 are joined on the services engine by connection system 90. This provides client 50 and subscribing provider 60 with at least one tunneled communication channel. These processes occur in server 100. However, the connections themselves are established in tunneling server 70.

While the discussion above refers to separate servers 100 and 70, this is not meant to imply that these two servers cannot exist in the same physical structure. It is often the case that, especially in high end data processing systems, multiple independent servers are provided in a single frame structure. However, in preferred embodiments of the present invention, servers 100 and 70 are provided in different frames for additional security, scalability, and robustness of operation.

While the invention has been described in detail herein in accordance with certain preferred embodiments thereof, many modifications and changes therein may be effected by those skilled in the art. Accordingly, it is intended by the appended claims to cover all such modifications and changes as fall within the true spirit and scope of the invention.

What is claimed is:

1. A method for establishing communication in a network, said method comprising the steps of:
identifying at least one party to a first server, via a predefined protocol;
determining whether conditions, as defined by said protocol, are satisfactory for communications; and
upon successful determination, providing a location in a second server, which is secure, for exchanging information in a manner in which parties involved are anonymous to one another, if desired, but with said parties being known to said first server.

2. The method of claim 1 in which there are a plurality of parties.

3. The method of claim 1 in which there are two parties, one of which is a client and the other of which is a provider.

4. The method of claim 1 in which said parties are both clients.

5. The method of claim 1 in which said parties are both providers.

6. The method of claim 1 in which said location is specified by an address and a port.

7. The method of claim 1 in which said protocol is defined in program code previously supplied to at least one of said parties.

8. The method of claim 1 in which said second server is a tunneling server.

9. The method of claim 8 in which said tunneling server does not enforce security.

10. The method of claim 1 in which said determining is carried out at least in part by matching keywords supplied by said parties.

11. The method of claim 1 in which said determining is carried out at least in part by matching communication modalities as specified by at least one of said parties.

12. The method of claim 1 in which said determining is carried out at least in part by authentication.

13. The method of claim 1 in which said parties specify, through said protocol, the type of connection to be provided.

14. The method of claim 13 in which the type of connection is selected from the group consisting of: one-to-one, one-to-many, many-to-one and many-to-many.

15. A system for establishing communication between parties, said system comprising:
a first processing unit running a web server and being capable of identifying at least two of said parties via a predefined protocol;
a dispatch service program running on said first processing unit for determining whether conditions, as defined by said protocol, are satisfactory for communications between at least two of said parties; and
a secure server, including a second processing unit and an available web location, as determined by said dispatch service program, through which said communications pass, whereby said parties are anonymous to one another but are known to said dispatch service program.

16. A method for establishing communication between at least two parties, said method comprising the steps of:
providing a first user with a first program coded protocol;
providing a second user with a second program coded protocol;
accessing a service engine on a first server through said first and second protocols by said respective users to establish criteria for said communication;
identifying at least one of said parties to said first server, via a respective one of said predefined protocols;
determining whether conditions, as defined by said protocols, are satisfactory for communications; and
upon successful determination, providing a location in a second server, which is secure, for exchanging information in a manner in which said parties are anonymous to one another, if desired, but with said parties being known to said first server.

17. The method of claim 16 in which at least one of said protocols is provided to at least one of said parties through a fee for service subscription to a provider of said servers.

18. A method for establishing communication with an expert, said method comprising the steps of:
acquiring a program coded protocol;
accessing a service engine on a first server through said program coded protocol to establish criteria for said communication;
determining whether criteria, as defined by said protocol, are satisfactory for said communications;
upon successful determining, providing a location in a second server, which is secure, for exchanging information with said expert in a manner in which the parties are anonymous to one another, if desired, but with the parties being known to said first server.

19. A method for establishing communication with a client seeking information from an expert, said method comprising the steps of:
acquiring a program coded protocol;
accessing a service engine on a first server through said program coded protocol to establish criteria for said communication;
determining whether criteria, as defined by said protocol, are satisfactory for said communications;
upon successful determining, providing a location in a second server, which is secure, for exchanging information with said client in a manner in which the parties are anonymous to one another, if desired, but with the parties being known to said first server.

20. A computer program product comprising media readable by a data processing system, said media containing instructions thereon for: identifying at least one party to a first server, via a predefined protocol; determining whether conditions, as defined by said protocol, are satisfactory for communications; and upon successful determination, providing a location in a second server, which is secure, for exchanging information in a manner in which parties involved are anonymous to one another, if desired, but with said parties being known to said first server.
